(19) United States
(12) Patent Application Publication
(10) Pub. No.: US 2018/0145869 A1
(43) Pub. Date: May 24, 2018

(54) DEBUGGING METHOD OF SWITCHES

(71) Applicants: INVENTEC (PUDONG) TECHNOLOGY CORPORATION, Shanghai City (CN); INVENTEC CORPORATION, Taipei City (TW)

(72) Inventors: Hsiang-Chun HU, Taipei City (TW); Yi-Lun LO, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/472,108

(22) Filed: Mar. 28, 2017

(30) Foreign Application Priority Data
Nov. 24, 2016 (CN) 201611050683.7

(51) Int. Cl. H04L 12/24

(52) U.S. Cl. CPC H04L 41/0654; H04L 41/0677; H04L 41/069

(57) ABSTRACT

A debugging method of switches is applied to a server device comprising the switches, a central processing unit (CPU) and a baseboard management controller (BMC). The CPU generates at least one control signal and transmits it to the switches as executing a mission which relates to transmitting a signal generated by a source device to a sink device. At least part of the switches builds a connection relationship according to the control signal and the switches in the connection relationship are electrically connected to the source device and the sink device. When an error occurs to the CPU or the switches during execution of the mission, the CPU resets the connection relationship. The BMC determines whether the error is removed. When the error is not removed, the BMC records the error, resets the server device, and then selectively sets the switches with a preset connection relationship.

### CROSS-REFERENCE TO RELATED APPLICATIONS

This non-provisional application claims priority under 35 U.S.C. § 119(a) on Patent Application No(s). 201611050683.7 filed in China on Nov. 24, 2016, the entire contents of which are hereby incorporated by reference.

### BACKGROUND

### Technical Field

This disclosure relates to a debugging method of switches, and particularly to a method for a base management controller (BMC) to remove an error occurring to switches.

### Related Art

With the popularity of internet service and cloud computing, more and more companies rely on data computer centers to process and store a large amount of data. A conventional data computer center includes a large amount of servers and nodes to remotely store, process or arrange the data. Nevertheless, with the varied requirements of clients and multiple services of the companies, a server is continuously evolved and upgraded.

In order to improve the transmission rate of the data, switches are configured to be the medium of data transmission in a motherboard of the server. The switches provide the data transmission with high bandwidth and low delay by a peripheral component interconnect express (PCIe) technique. However, the switches in the motherboard of a modern server is controlled and set by the central processing unit (CPU) in the motherboard of the server. When a shutdown or other malfunction occurs to the CPU, the server cannot record the error automatically, so that a server manager cannot find the reason why the error occurred to the server to correct the error.

### SUMMARY

According to one or more embodiments of this disclosure, the debugging method is applied to a server device which comprises the switches, a CPU and a baseboard management controller (BMC). The debugging method includes the following steps: generating at least one control signal and transmitting the control signal to the switches when the CPU executes a mission, which relates to transmitting a signal generated by a source device to a sink device; building a connection relationship among at least a part of the switches, the source device and the sink device according to the control signal, wherein the switches in the connection relationship are electrically connected to the source device and the sink device; when an error occurs to the CPU or the switches during the execution of the mission, resetting the connection relationship by the CPU; determining, by the BMC whether the error is removed; and when the error is not removed, recording the error, resetting the server device, and selectively setting the switches with a preset connection relationship by the BMC after resetting the server device.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a server device in an embodiment of this disclosure;

FIG. 2 is a flow chart of a debugging method of switches in an embodiment of this disclosure;

FIG. 3 is a flow chart of a debugging method of switches in another embodiment of this disclosure;

FIG. 4 is a flow chart of a debugging method of switches in yet another embodiment of this disclosure; and

FIG. 5 is a flow chart of a debugging method of switches in yet another embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

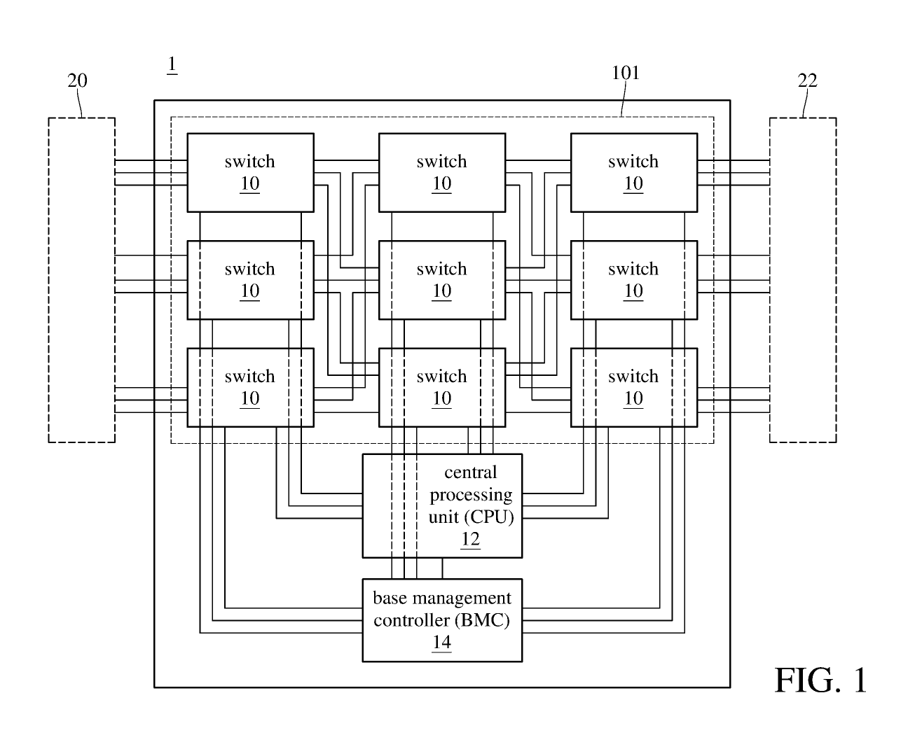

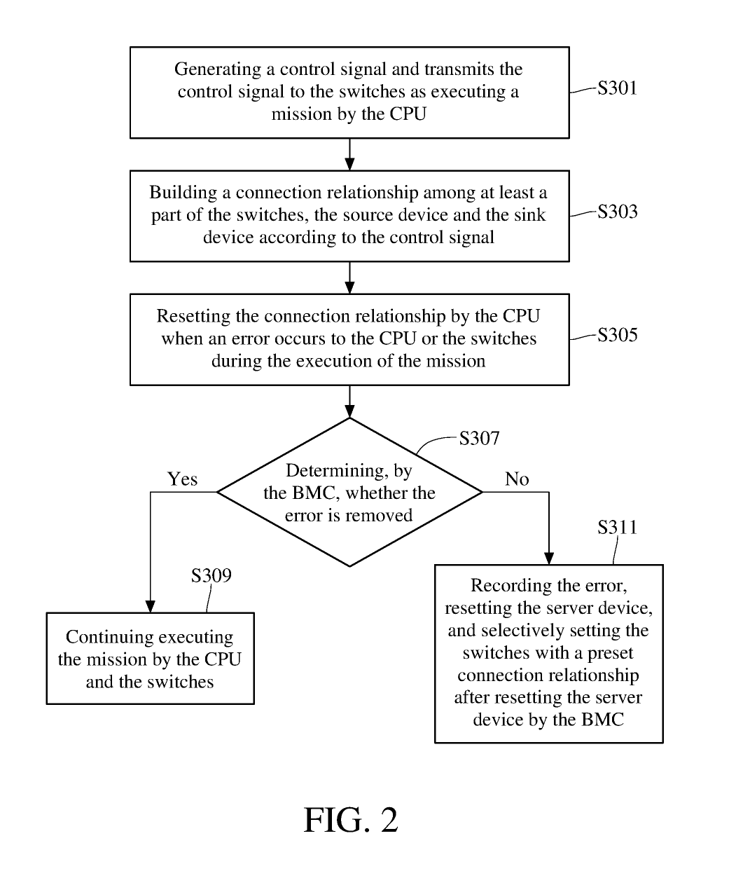

Please refer to FIG. 1 and FIG. 2 wherein FIG. 1 is a functional block diagram of a server device in an embodiment of this disclosure, and FIG. 2 is a flow chart of a debugging method of switches in an embodiment of this disclosure. As shown in the figures, a server device 1 includes a number of switches 10, a CPU 12 and a baseboard management controller (BMC) 14. The switches 10 are arranged in three rows and three columns to be a switch array 101. The switches 10 in the first row are electrically connected to the switches 10 in the second row respectively, and the switches 10 in the second row are electrically connected to the switches 10 in the third row. Moreover, the switches 10 in the first row are connected to a source device 20 in the server device 1, and the switches 10 in the third row are connected to a sink device 22. For example, the source device 20 or the sink device 22 is a graphics processing unit (GPU), a host, a network interface card (NIC), a host bus adapter (HBA) or other suitable device, and is not limited in this disclosure.

Each of the switches 10 in the switch array 101 is electrically connected to the CPU 12 and the BMC 14 respectively, and the CPU 12 is electrically connected to the BMC 14. In an embodiment, the CPU 12 is electrically connected to the management port of the switches 10, the BMC 14 is connected to the switches 10 via an inter-integrated circuit (PC) or a general-purpose input/output (GPIO) transmission interface, the CPU 12 is connected to the BMC 14 via a peripheral component interconnect express (PCIe) bus, and this disclosure is not limited to them. For example, in the topology shown in FIG. 1, any number of switches, CPUs and BMCs may be included in the server device.

In an embodiment, in step S301, when the CPU 12 executes a mission, the CPU 12 generates at least one control signal and transmits the control signal to the switches 10. In step S303, at least part of the switches 10 builds a connection relationship among the switches 10, the source device 20 and the sink device 22 according to the control signal. For example, the control signal, generated by the CPU 12, is transmitted to the switches 10 which build the connection relationship, or is transmitted to each of the switches 10. This disclosure does not intend to limit which switch the control signal is transmitted to. The control signal indicates each of the switches 10 to choose a pin for receiving a signal and a pin for outputting the signal. In other words, the mission executed by the CPU 12 relates to transmitting the signal generated by the source device 20 to the sink device 22. Therefore, the CPU 12 generates the control signal which indicates each of the switches 10, connected to the source device 20 and the sink device 22, to choose a pin for receiving the signal and a pin for outputting the signal, in order to build a connection relationship so that the signal generated by the source device 20 can be transmitted to the sink device 22 via the switches in the connection relationship.

In step S305, when an error occurs to the CPU 12 or the switches 10 during the execution of the mission, the CPU 12 resets the connection relationship. A shutdown or another malfunction may occur to the CPU 12 during the execution of mission. For example, an error occurs to the CPU 12 or the switches 10 during the execution of the mission, or an incorrect control signal generated by the CPU 12 causes a incorrect connection relationship among the switches 10, the source device 20 and the sink device 22, so that the signal of the source device 20 cannot be transmitted to the sink device 22 successfully. One or more errors may occurs to the CPU 12 or the switches 10 or both of them during the execution the mission, and this disclosure is not limited to these situations.

In step S307, the BMC 14 determines whether the error is removed. When the error is removed, in step S309, the CPU 12 and the switches 10 continue executing the mission, or execute the next mission. In other words, when the CPU 12 removes the shutdown or other malfunction, or the CPU 12 regenerates a new control signal to correct the error in the connection relationship among the switches 10, the source device 20 and the sink device 22, the error state of the CPU 12 or the switches 10 may be recovered and then the CPU 12 and the switches 10 continue executing the mission or execute the next mission.

In step S311, when the error is not removed (the error state of the CPU 12 or the switches 10 cannot be recovered), the BMC 14 records the error, resets the server device 1, and selectively sets the switches 10 by a preset connection relationship. In an embodiment, the BMC 14 reads the state of the CPU 12 via the PCIe bus, and reads the state of the switches 10 via the I²C or the GPIO. The BMC 14 stores the states of the CPU 12 and the switches 10 as an error record. Therefore, after the server device 1 is reset, the error, which occurred to the CPU or the switches 10, can still be analyzed by searching the error record in the BMC 14 so that a follow-up error may be avoided.

When the error occurring to the CPU 12 or the switches 10 is still not removed after the server device 1 is reset, the BMC 14 sets the switches 10 with the preset connection relationship. In an embodiment, each of the switches 10 has a pin correspondence table which is stored in the electrically-erasable programmable read-only memory (EEPROM) of the switch 10. Each pin correspondence table indicates preset connections of the pins of each switch 10 respectively. In other words, the pin correspondence table indicates the pins are respectively connected to one of the switches 10, the source device 20 or the sink device 22. When the error in the CPU 12 or the switches 10 is still not removed after the server device 1 is reset, the BMC 14 or the CPU 12 controls each switch 10 resets the setting of the pins according the pin correspondence table stored in the EEPROM.

Accordingly, the server device 1 is capable of recording the error, which occurs to the CPU 12 or the switches, by the BMC 14. Furthermore, when the error state cannot be recovered, the server device 1 is reset so that the CPU 12 or the switches 10 can continue executing the mission and execute the next mission.

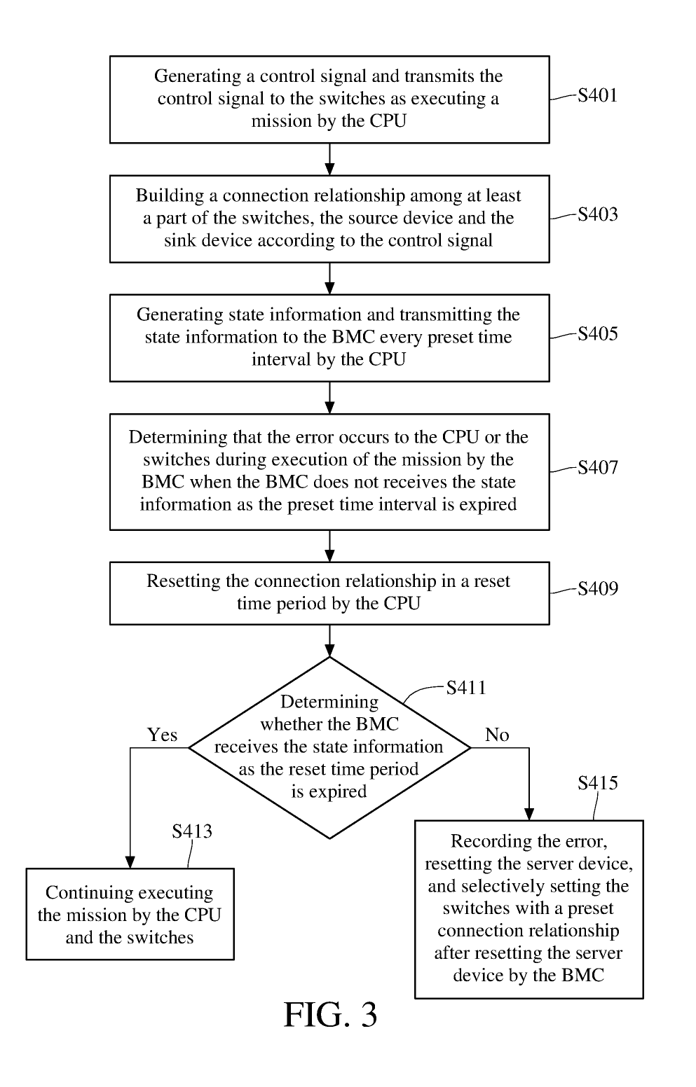

Please refer to FIG. 1 and FIG. 3 wherein FIG. 3 is a flow chart of a debugging method of switches in another embodiment of this disclosure. As shown in FIG. 3, the debugging method is applied to the server device. For the convenience of explanation, the debugging method is similarly explained by the server device 1 shown in FIG. 1, but this disclosure is not limited to it.

In step S401, the CPU 12 generates at least one control signal and transmits the control signal to the switches 10 as executing a mission. In step S403, at least part of the switches 10 builds a connection relationship according to the control signal. Similarly, this disclosure does not intend to limit whether the control signal generated by the CPU 12 is transmitted to the switches 10 which build the connection relationship or all the switches 10. The mission executed by the CPU 12 relates to transmitting the signal generated by the source device 20 to the sink device 22, so that the CPU 12 generates the control signal, which commands the switches 10 to build a connection relationship, according to the switches 10 connected to the source device 20 and the sink device 22. Therefore, the signal generated by the source device 20 can be transmitted to the sink device 22 via the switches in the connection relationship.

In step S405, the CPU 12 generates state information every preset time interval to inform the BMC 14 about the state of the execution of the mission. In step S407, when the BMC 14 does not receives the state information as the preset time interval is expired, the BMC 14 determines that the error occurs to the CPU 12 or the switches 10 during the execution of the mission. At that time, in step S409, the CPU 12 tries to reset the connection relationship among the switches, the source device and the sink device in a reset time period in order to recover the error state.

In step S411, as the reset time period is expired, the BMC 14 determine whether the error is removed or not according to whether the BMC 14 receives the state information generated by the CPU 12 or not. When the error is removed, in step S413, the CPU 12 and the switches 10 continue executing the mission or execute the next mission. In other words, when the error state of the CPU 12 or the switches 10 is recovered, the CPU 12 and the switches 10 continue executing the mission or execute the next mission.

In step S415, when the error state of the CPU 12 or the switches 10 cannot be recovered, and it means the error is not removed, the BMC 14 records the states of the CPU 12 and the switches 10, and resets the server device 1. After the server device 1 is reset, the BMC 14 determines whether the error in the CPU 12 or the switches 10 is removed similarly according to the state information generated by the CPU 12, and selectively sets the switches 10 with the preset connection relationship according to the determined result.

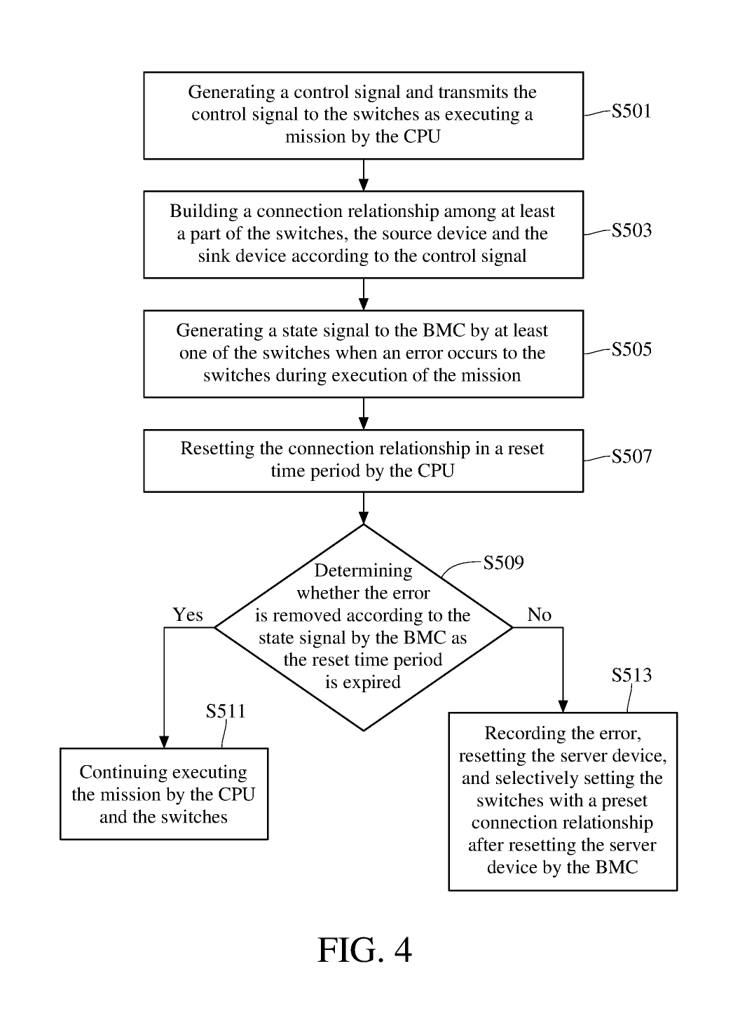

Please refer to both FIG. 1 and FIG. 4. FIG. 4 is a flow chart of a debugging method of switches in yet another embodiment of this disclosure. As shown in FIG. 4, the debugging method is similarly applied to any server device which includes switches, a CPU and a BMC. For convenience of explanation, the debugging method is similarly explained by the server device 1 shown in FIG. 1, but this disclosure is not limited to it.

In step S501, the CPU 12 generates at least one control signal and transmits the control signal to the switches 10 as executing a mission. In step S403, at least part of the switches 10 builds a connection relationship according to the control signal wherein the mission executed by the CPU 12 relates to transmitting the signal generated by the source device 20 to the sink device 22. The CPU 12 generates the control signal according to the mission to command the switches 10 to build the connection relationship so that the switches 10 can transmit the signal generated by the source device 20 to the sink device 22.

In step S505, when an error occurs to the switches 10 during the execution the mission, at least one of the switches 10 generates a state signal and transmits the state signal to the BMC 14 in order to inform the BMC 14 that the error occurs. For example, the state signal is an interrupt signal or an error signal, and is generated by the switch in which the error occurs. In step S507, the CPU 12 tries to reset the connection relationship among the switches 10, the source device 20 and the sink device 22 in a reset time period to recover the error state.

In step S509, as the reset time period is expired, the BMC 14 determines whether the error is removed or not according to the state signal generated by the switch 10. In step S511, when the error is removed, the CPU 12 and the switches 10 continue executing the mission or execute the next mission. In step S513, when the BMC 14 determines the error is not removed according to the state information generated by the switch 10, the BMC 14 records the states of the CPU 12 and the switches 10, and reset the server device 1.

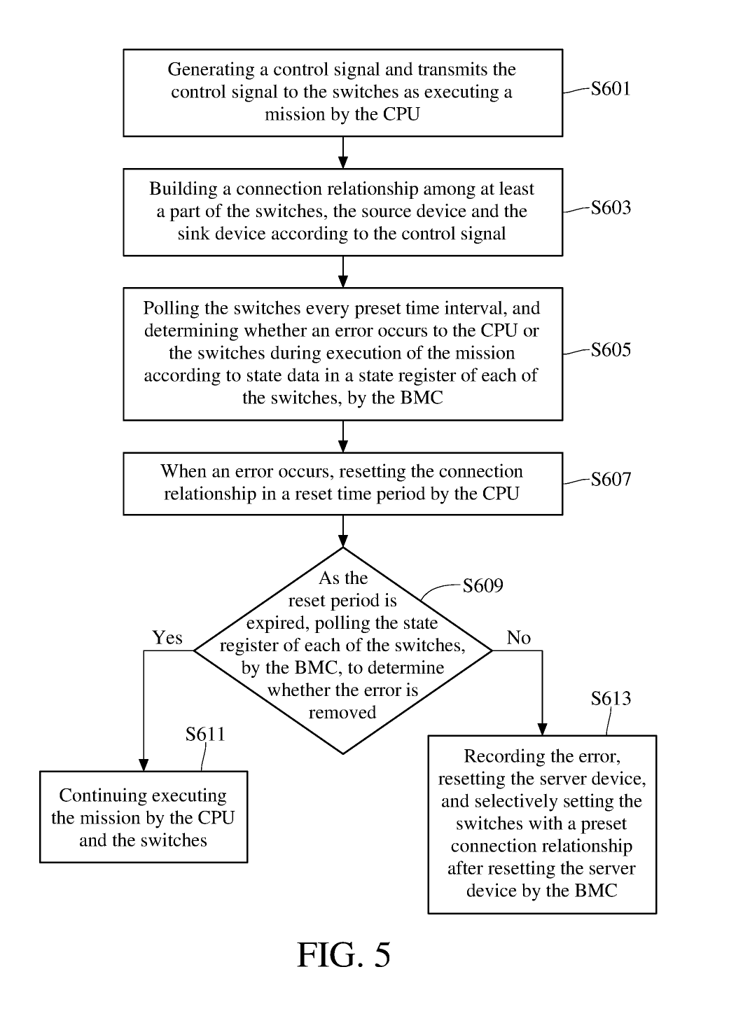

Please refer to both FIG. 1 and FIG. 5. FIG. 5 is a flow chart of a debugging method of switches in yet another embodiment of this disclosure. As shown in FIG. 5, the debugging method is similarly applied to any server device which includes switches, a CPU and a BMC. For convenience of explanation, the debugging method is similarly explained by the server device 1 shown in FIG. 1, but this disclosure is not limited to it.

In step S601, the CPU 12 generates at least one control signal and transmits the control signal to the switches 10 as executing a mission. In step S603, at least part of the switches 10 builds a connection relationship according to the control signal. The switches 10 in the connection relationship are configured to transmit the signal generated by the source device 20 to the sink device 22. In step S605, the BMC 14 polls the switches 10 every preset time interval, and determines whether an error occurs to the CPU 12 or the switches 10 during the execution of the mission according to a state register of each of the switches 10.

In step S607, when the error occurs, the CPU 12 tries to resets the connection relationship of the switches 10 in a reset time period in order to recover the error state. In step S609, as the reset time period is expired, the BMC 14 polls each of the switches 10 to determine whether the error is removed or not. In step S611, when the error is removed, the CPU 12 and the switches 10 continue executing the mission or execute the next mission. In step S613, when the BMC 14 determines the error is not removed according to the state signal generated by the switch 10, the BMC 14 records the states of the CPU 12 and the switches 10, and resets the server device 1.

In view of the above statement, one or more embodiments provide a debugging method of switches. The debugging method includes determining whether an error occurs to the CPU or the switches according to the states of the CPU and the switches by the BMC. When the CPU fails to remove the error, the method also includes recording the reason for the error occurring to the CPU or the switches and resetting the server device, so that the error may be removed. When the error is still not removed after the server device is reset, the BMC further resets the connection relationship among the switches, the source device and the sink device for aiding debugging.

What is claimed is:

1. A debugging method of switches, applied to a server device which comprises the switches, a central processing unit (CPU) and a baseboard management controller (BMC), and the method comprising:
generating at least one control signal and transmitting the control signal to the switches as executing a mission, related to transmitting a signal generated by a source device to a sink device, by the CPU;
building a connection relationship among at least a part of the switches, the source device and the sink device according to the control signal, wherein the switches in the connection relationship are electrically connected to the source device and the sink device;
resetting the connection relationship by the CPU when an error occurs to the CPU or the switches during execution of the mission;
determining, by the BMC, whether the error is removed; and
when the error is not removed, by the BMC, recording the error, resetting the server device, and selectively setting the switches with a preset connection relationship after resetting the server device.

2. The debugging method according to claim 1, wherein the CPU generates state information and transmits the state information to the BMC every preset time interval, the state information relates to a state of the CPU executing the mission, and the method further comprises:
determining that the error occurs to the CPU or the switches during the execution of the mission by the BMC when the BMC does not receives the state information as the preset time interval is expired.

3. The debugging method according to claim 2, wherein the CPU further resets the connection relationship in a reset time period, and when the BMC does still not receive the state information as the reset time period is expired, the BMC determines that the error is not removed.

4. The debugging method according to claim 1, wherein when the error occurs to the CPU or the switches during the execution of the mission, at least one of the switches generates a state signal and transmits the state signal to the BMC.

5. The debugging method according to claim 4, wherein the CPU further resets the connection relationship in a reset time period, and as the reset time period is expired, the BMC determines whether the error is removed, according to the state signal.

6. The debugging method according to claim 1, wherein the BMC polls the switches every preset time interval, and determines, according to state data in a state register of each of the switches, whether the error occurs to the CPU or the switches during the execution of the mission.

7. The debugging method according to claim 6, wherein the CPU resets the connection relationship in a reset time period, and as the reset time period is expired, the BMC polls the state register of each of the switches to determine whether the error is removed.

8. The debugging method according to claim 1, wherein when the error is not removed, the method further comprises:
reading states of the CPU and the switches and recording the states of the CPU and the switches as an error record by the BMC.

9. The debugging method according to claim 1, wherein after the server device is reset, the BMC further determines whether the error is removed, according to state information generated by the CPU, a state signal generated by at least one of the switches, state data in a state register of each of the switches, or a combination thereof, and when the error is not removed, the BMC sets the switches with the preset connection relationship.

10. The debugging method according to claim 1, wherein each of the switches has a pin correspondence table, each of the pin correspondence tables indicates the preset connection relationship, and when the error is still not removed after the server device is reset, the switches are reset according to the pin correspondence tables respectively.
